(19) United States
(12) Patent Application Publication
(10) Pub. No.: US 2025/0062568 A1
(43) Pub. Date: Feb. 20, 2025

(54) ELECTRICAL CONNECTION SYSTEM FOR ELECTRIC VEHICLES

(71) Applicant: Aptiv Technologies AG, Schaffhausen (CH)

(72) Inventors: Loganathan PARTHEEBAN, Tamil Nadu (IN); René LEHMANN, Fürth (DE)

(21) Appl. No.: 18/782,427

(22) Filed: Jul. 24, 2024

(30) Foreign Application Priority Data
Aug. 14, 2023 (EP) 23191280.9

(51) Int. Cl. H01R 13/56; H01R 13/627; H01R 24/28; H01R 24/76; H01R 43/16; H01R 43/18

(52) U.S. Cl. CPC H01R 13/562; H01R 13/6271; H01R 24/28; H01R 24/76; H01R 43/16; H01R 43/18; H01R 2201/26

(57) ABSTRACT

This disclosure relates to an electrical connection system for automotive applications, featuring an outer housing with a defined mating direction and a female terminal. The female terminal includes a first elongate portion aligned parallel to the mating direction and partially housed within the outer housing, a second elongate portion oriented differently, and a bent portion between them. The first elongate portion has a receiving end for mating with a male terminal, while the bent portion includes supporting members to secure the female terminal within the outer housing, preventing movement. This innovative design ensures stable and reliable electrical connections in automotive systems.

### CROSS-REFERENCE TO RELATED APPLICATION

This application claims the benefit of and priority to European Patent Application No. 23191280.9 filed on Aug. 14, 2023, the contents of which are incorporated by reference herein.

### TECHNICAL FIELD

The disclosure relates to an electrical connection system, in particular a system for automotive applications, having at least one female terminal arranged partially in an outer housing, the female terminal being configured to engage with a corresponding male terminal. The disclosure further relates to a method for assembling a respective electrical connection system.

### BACKGROUND

In recent years the automotive sector has been facing a shift towards electric vehicles, which are becoming more and more important and popular among consumers. This shift, in turn, is accompanied by a growing demand for electrical parts and components. This also increases the demand for electrical connection systems, which are useful to connect one electrical part to another electrical part. On the one hand such electrical connections are useful to transmit electrical power to electric consumers. On the other hand, such electrical connections facilitate the distribution of data in automotive vehicles.

These types of electrical connection systems comprise a female connector comprising an outer housing and a female terminal, which can engage with a corresponding male terminal for providing electrical energy. The female terminals are usually bent, for instance to about 90° so as to allow for flexible arrangements and orientations of wires.

The present situation of such an electrical connection system, in particular as used in the automotive sector, reveals several drawbacks.

For instance, it is difficult to keep the female terminal in the female connector outer housing in a substantially central position. In turn, mating with a male terminal is adversely affected. In particular, the female terminal may be off-centered, which is detrimental for mating. In addition, the male terminal can damage the female terminal during mating, which adversely affects the electrical connection. Further, the female terminals are usually not fixed, which makes them susceptible to movements such that they could touch an inner surface of the outer housing. This can lead to damages of the female terminal. In addition, the absence of any fixation leads to substantial wiggling of the female terminal in particular in an assembled condition if no overmold is applied and/or during the overmold process.

Overall, some electrical connection systems are thus unsuitable to be used in the automotive sector, which can lead to an increase in junk material. In turn, this significantly increases manufacturers' costs.

Against this background, there is a need to improve the presently known electrical connection systems, as the present situation fails to address manufacturers' needs.

It is thus an object of the present disclosure to overcome some or all of the deficiencies of the prior art. In particular, it is an object of the disclosure to provide for an electrical connection system that allows to be easily assembled with a firm, stationary, and predefined arrangement. In addition, mating with a male terminal should be simplified. It is a general objective to reduce costs and to increase flexibility by the provision of an improved electrical connection system.

### SUMMARY

These objectives are achieved partially or wholly, according to the disclosure, by a method or device having the features set forth in the claims. The claims form an integral part of the technical description provided herein in connection with the disclosure.

An aspect of the disclosure relates to an electrical connection system for automotive applications, the system comprising: an outer housing defining a mating direction; at least one female terminal comprising a first elongate portion oriented substantially parallel to the mating direction and being received at least partially within a hollow portion of the outer housing, a second elongate portion oriented in a different direction than the mating direction, and a bent portion arranged between the first and second elongate portion; wherein the first elongate portion has a receiving portion opposite to the bent portion for mating with a corresponding male terminal; wherein the bent portion has at least one supporting member for supporting the female terminal on a surface of the outer housing such that movement of the female terminal in the outer housing is substantially prevented.

In this manner, the present disclosure provides an electrical connection system, which has the advantage that it can be easily assembled. The arrangement of the individual components of the electrical connection system, in particular of the female terminal is maintained in a predetermined manner. This facilitates mating with a corresponding male terminal. Substantially no failures and/or damages during mating thus occur. The electrical connection system can hence be employed in various fields of application wherever mating with a male terminal is required. The overall flexibility of the field of applications is thus increased as no particular attention is required for mating. For instance, no particular concerns by operators and/or robots are required for mating. The costs associated with manufacturing and assembling are thus reduced.

Attributable to the supporting member, the female terminal is securely maintained on the surface of the outer housing. This is particularly beneficial for manufacturing steps of the electrical connection system during which a cover and/or an overmold has been applied. During such manufacturing steps, the prior art solutions are usually prone to wiggling and/or movements of the female terminals, which makes an accurate positioning of the female terminal in an outer housing of prior art solutions difficult. According to the electrical connection system proposed in this disclosure, the supporting member has the advantage that any accidental movement of the female terminal is prevented. The female terminal is thus protected against unintentional rearrangement, reorientation, shifting or similar.

All in all, the combination the supporting member of the bent portion of the female terminal significantly facilitates assembly and improves the reliability of the electrical connection system. As understood, also serviceability thereof is enhanced.

As used herein, any terminal may be understood as an electrical terminal that allows for electrical connection.

The first elongate portion and the second elongate portion are understood as each having a shape, which has at least one dimension being larger than any of the other two dimensions. Hence, one may recognize an elongate axis, which defines the first portion and the second portion as the first elongate portion and the second elongate portion, respectively. The shapes of the first elongate portion and the second elongate portion may be different from one another.

The first elongate portion and the second elongate portion may be portions of the female terminal of any length, respectively. As understood, since an extension of the first elongate portion and the second elongate portion may intersect at an intersection point or intersection edge, the first elongate portion and the second elongate portion itself may not necessarily abut to the bent portion between these two elongate portions. Nevertheless, it is preferred when the first elongate portion and the second elongate portion each abut the bent portion on opposing sides thereof.

The second elongate portion being oriented in a different direction than the mating direction means that their elongate axes are not parallel to one another. Preferably, they are oriented such that an angle can be defined in the bent portion as described elsewhere herein. The first elongate portion, the second elongate portion, and the bent portion may be arranged substantially on one plane, the plane being parallel to the mating direction.

The mating direction may be understood by the skilled person as the direction in which a male terminal and a female terminal move so as to provide for a mating condition. The unmating direction may be parallel to the mating direction but oriented in the opposite direction.

The hollow portion of the outer housing may be sufficiently large to accommodate the first elongate portion. It may be larger so as to accommodate one or more further elements, such as a shielding element as described elsewhere herein.

The bent portion may be understood as encompassing a part of the female terminal in which the different orientation of the first elongate portion and the second elongate portion becomes visually apparent. This may be illustrated as follows. The first elongate portion and the second elongate portion may be implemented by strips of metal and an extension of each of the first elongate portion and the second elongate portion may define an intersection point or intersection edge. A part encompassing this point or edge as well as a proximity to this point or edge may be referred to as the bent portion. In this manner, the bent portion may comprise a part of the extension of the first elongate portion and/or a part of the extension of the second elongate portion. In other words, the bent portion of the female terminal may not be limited to the mathematical point or edge at which an extension of each of the first elongate portion and the second elongate portion intersect.

The receiving portion may be arranged substantially at one end of the female terminal.

The supporting member may be understood as a structural element with the intended purpose to substantially prevent movement or the like of the female terminal in the outer housing. In particular, movement of the first elongate portion may substantially be prevented. As understood by the skilled person, the supporting member requires more than a mere arbitrary part, surface, or the like, which affects for instance the center of mass of the female terminal merely by its presence.

It is understood that the surface of the outer housing may be facing the second elongate portion. In one example, the surface may have a normal, the normal being parallel to the mating direction.

The electrical connection system may comprise a plurality of female terminals. Preferably, two female terminals are comprised by the electrical connection system. These two female terminals may substantially be the same.

It is noted that when feature, aspects, and/or embodiments are described herein by the term “substantially”, manufacturing tolerances usually have to be taken into consideration. In this manner, minor deviations during any kind of manufacturing, assembling or the like may pertain. Further, manufacturing tolerances, aging effects, or other minor defects or the like may pertain. These are all encompassed by the term “substantially”.

In a preferred embodiment of the electrical connection system, the at least one supporting member is arranged such that a free edge of the supporting member contacts the surface of the outer housing at least partially.

The free edge contacting the surface at least partially has the advantage that the female terminal is supported to a greater extent. The free edge of the supporting member may contact the surface additionally or alternatively with the whole edge's surface facing the surface of the outer housing.

In a preferred embodiment of the electrical connection system, the at least one supporting member is bent in the mating direction and extends from the second elongate portion such that the free edge substantially abuts the surface along its length in the direction of the second elongate portion.

This has the advantage that the supporting effect is enhanced. In turn, the mating can be improved.

The direction of the second elongate portion may be understood by the skilled person as the elongate direction of the second portion.

In a preferred embodiment of the electrical connection system, the at least one supporting member has the shape of a wing.

The wing has the advantage that it is a highly accepted structural element that can be easily implemented and handled in the manufacturing process. The wing enhances the supporting effect of the supporting member.

In a preferred embodiment of the electrical connection system, the at least one supporting member is integrally formed with the female terminal as a single piece, wherein the female terminal and the at least one supporting member are preferably made from stamped and bent sheet metal.

The manufacturing process can thus be improved. An integral formation reduces the number of separate pieces that are needed. To be made from stamped and bent sheet metal means that the female terminal may have undergone a stamping and bending process. The skilled person readily recognizes the differences from such manufacturing processes as compared to the provision of separated pieces, as separate pieces demand attachment means. The preferred embodiment described herein has the advantage that the supporting member is a rigid and firm structure on its own without the need for any attachment means.

In a preferred embodiment of the electrical connection system, the surface of the outer housing is provided with at least one corresponding recess so as to accommodate the least one supporting member at least partially.

This has the advantage that securing and maintaining the female terminal in a correct position is enhanced. The recces may have a similar shape as a part of the supporting member. In particular, the recess may have a similar shape as a free edge of the supporting member described elsewhere herein.

In a preferred embodiment of the electrical connection system, the at least one supporting member comprises a slit on an edge facing the second elongate portion, the slit extending along the elongate direction of the second elongate portion, wherein the slit preferably starts in proximity to an intersection of the first elongate portion and the second elongate portion and extends in the direction along the second elongate portion away from the intersection, wherein the slit preferably extends to at least 5%, preferably at least 10%, preferably at least 20%, preferably at least 30%, and/or of at most 90%, preferably at most 80%, preferably at most 70%, preferably at most 60%, preferably at most 50%, preferably at most 40% of the length of the supporting member in a direction along the second elongate portion.

This slit the advantage that manufacturing and/or provision of the female terminal is improved. For instance, the slit facilitates that the supporting member can be bent more easily. This makes it easier to bend the supporting member such that it abuts the surface of the outer housing substantially with its whole free edge. In this manner, the abutment of the supporting member and the surface can be adjusted more easily.

On the one hand, the slit should not extend over such a length that stability of the supporting member may be impaired. On the other hand, the slit should extend to a sufficient length to facilitate an easier bending during manufacturing and/or assembling. According to the values specified here, an optimum balance was found.

In a preferred embodiment of the electrical connection system, the first elongate portion and the second elongate portion intersect in the bent portion with a bending radius of between 0.05 mm to 0.8 mm, preferably between 0.1 mm to 0.6 mm, preferably between 0.2 mm to 0.4 mm.

A smaller bending radius means that the supporting member may have more space on the bent portion. However, the bending radius should not be too small as this increases the mechanical stresses in the female terminal, which could be detrimental for electrical transmission. The values specified here provided an optimum compromise between these conflicting requirements.

In a preferred embodiment of the electrical connection system, the at least one supporting member has a width in a direction perpendicular to the second elongate portion towards the surface of at least 0.2 mm, preferably at least 0.4 mm, preferably at least 0.6 mm, preferably at least 0.8 mm, preferably at least 1 mm, and/or of at most 4 mm, preferably at most 2 mm, preferably at most 1.6 mm, preferably at most 1.4 mm, preferably at most 1.2 mm, preferably at most 1 mm.

This ensures that an optimum width of the supporting member is achieved. On the one hand, the width should not be too large, as this adversely affects waste of material. In addition, a larger width may entail a possibility of instability of the female terminal. On the other hand, the width should not be too small, as this compromises the provision of maintaining a certain distance, for instance a distance of the receiving portion of the first elongate portion to an opening of the outer housing as described elsewhere herein. According to the values specified here, an optimum balance was found.

The width of the at least one supporting member may additionally or alternatively be measured in a direction along the mating direction. It is preferred that the mating direction is substantially perpendicular to the second elongate portion of the female terminal.

In a preferred embodiment of the electrical connection system, the at least one supporting member has a length in a direction along the second elongate portion of at least 0.4 mm, preferably at least 0.6 mm, preferably at least 0.8 mm, preferably at least 1 mm, preferably at least 1.5 mm, and/or of at most 4 mm, preferably at most 3 mm, preferably at most 2 mm, preferably at most 1.8 mm, preferably at most 1.5 mm.

This ensures that an optimum length of the supporting member is achieved. On the one hand, the length should not be too large, as this adversely affects waste of material. On the other hand, the length should not be too small, as this compromises the beneficial supporting effect of the female terminal on the surface of the outer housing. Thus, the inventors found that an optimum balance according to the proposed values here should be struck.

In a preferred embodiment of the electrical connection system, the first elongate portion and the second elongate portion intersect at the bent portion by an angle of at least 60°, preferably at least 70°, preferably at least 80°, preferably at least 85°, and/or by an angle of at most 120°, preferably at most 110°, preferably at most 100°, preferably at most 95°, most preferably by an angle of about 90°.

In a preferred embodiment of the electrical connection system, the surface is a top surface arranged on an end of the outer housing opposite to the receiving portion and substantially perpendicular to the mating direction.

In a preferred embodiment of the electrical connection system, the bent portion encompasses a portion of the female terminal of at least 1 time, preferably at least 2 times, preferably at least 3 times, preferably at least 4 times, preferably at least 6 times, preferably at least 8 times, preferably at least 10 times, and/or of at most 20 times, preferably at most 16 times, preferably at most 14 times, preferably at most 12 times, preferably at most 10 times of a bending radius of the intersection of an extension of the first elongate portion and an extension of the second elongate portion.

As described elsewhere herein, the bent portion of the female terminal may not be limited to the mathematical point or edge at which an extension of each of the first elongate portion and the second elongate portion intersect.

In a preferred embodiment of the electrical connection system, the bent portion has two supporting members arranged substantially symmetrically on opposite sides of the bent portion, wherein the surface of the outer housing is provided with two corresponding recesses arranged substantially symmetrically on opposite sides of the bent portion so as to accommodate the two supporting members at least partially.

Preferably, the at least one supporting member protrudes from the second elongate portion substantially perpendicularly.

Preferably, the outer housing comprises at least one opening to which the receiving portion of the at least one female connector is directed, wherein the receiving portion is arranged substantially centrally in the opening as seen along the mating direction.

Preferably, the electrical connection system further comprises a second female terminal arranged in a plane substantially parallel to the first female terminal, wherein the system preferably comprises at least one shielding element with a through hole for receiving the at least one female terminal, the shielding element for being received within the hollow portion of the outer housing, wherein the system preferably comprises a cover arranged on top of the surface of the outer housing for covering the outer housing and the at least one female terminal at least partially, wherein the system preferably comprises at least one wire connected to the second elongate portion at an end portion thereof opposite the bent portion of the female terminal, wherein the system preferably comprises an overmold arranged on top of the cover configured to accommodate the cover and the at least one wire at least partially, wherein the system preferably comprises a sealing element arranged between the overmold and the outer housing.

A further aspect is related to a method for assembling an electrical connection system, the method comprising the steps of: providing an electrical connection system according to any one of the preceding claims; optionally providing a sealing element between the overmold and the outer housing; optionally connecting at least one wire to the second elongate portion at an end portion thereof opposite the bent portion of the female terminal; providing a cover on top of the surface of the outer housing for covering the outer housing and the at least one female terminal at least partially; providing an overmold on top of the cover configured to accommodate the cover and the at least one wire at least partially.

The method comprises all advantages of the electrical connection system described herein. Particularly, it is noted that the method as described herein may include all aspects and/or embodiments described herein, even if not expressly described as a method but rather with reference to the electrical connection system. It is also to be understood that the features and advantages described with reference to the electrical connection system may equally be applicable to the method as described herein.

### BRIEF DESCRIPTION OF THE DRAWINGS

FIG. 1 illustrates an electrical connection system according to the prior art.

FIG. 2a illustrates an electrical connection system in a schematic cross-sectional view from a side according to the prior art.

FIG. 2b illustrates the electrical connection system of FIG. 2a with a male terminal in a mating condition according to the prior art.

FIG. 2c illustrates the electrical connection system of FIG. 2a from a bottom view according to the prior art.

FIG. 3 illustrates an electrical connection system in a schematic cross-sectional view from a side according to some embodiments.

FIG. 4 illustrates an electrical connection system in a cross-sectional view from a side according to some embodiments.

FIG. 5 illustrates an electrical connection system in an isometric view according to some embodiments.

FIG. 6 illustrates a manufacturing process of a female terminal in a first step according to some embodiments.

FIG. 7 illustrates a manufacturing process of a female terminal in a second step according to some embodiments.

FIG. 8 illustrates a manufacturing process of a female terminal in a third step according to some embodiments.

### DETAILED DESCRIPTION

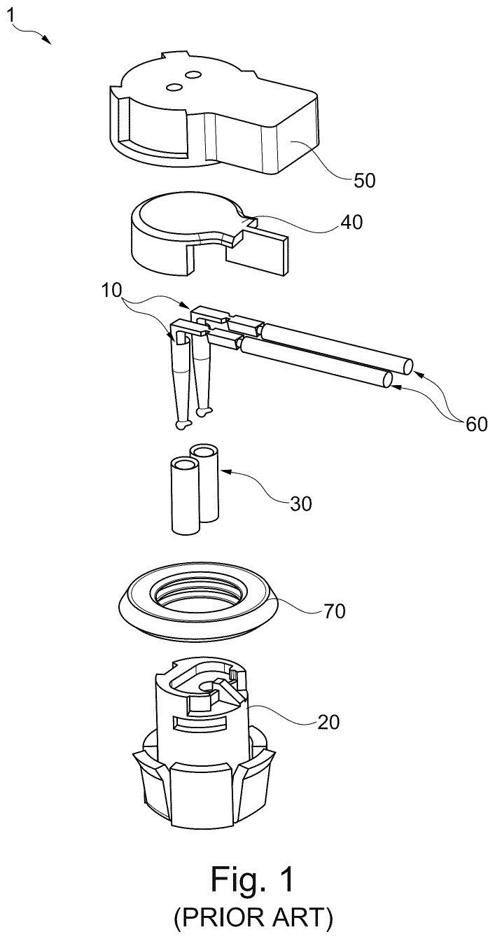

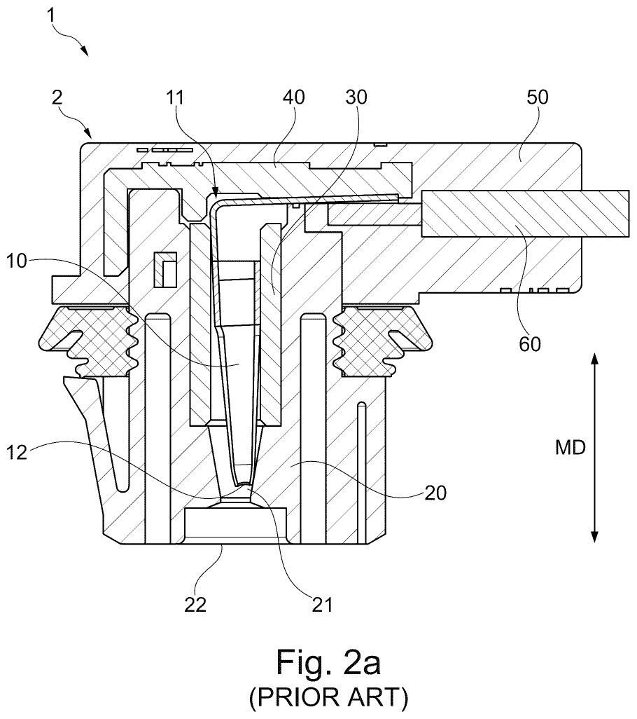

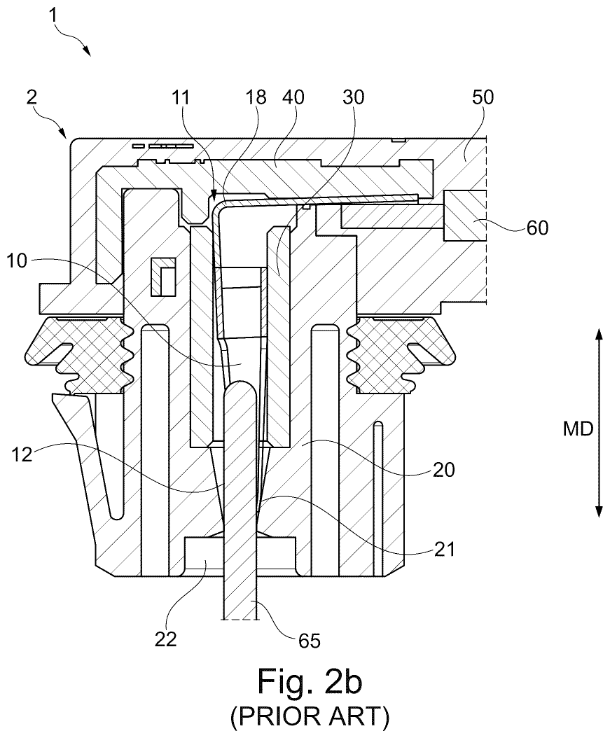

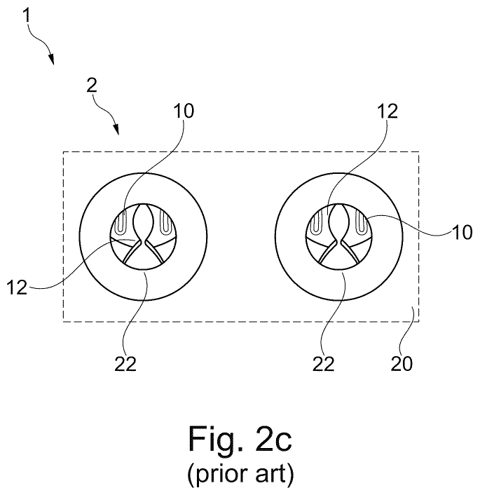

FIG. 1, FIG. 2a, FIG. 2b, and FIG. 2c show an electrical connection system 1 according to the prior art. Further, some features may also be compatible with the electrical connection system 1 of the present disclosure. FIG. 1 is an exploded view and shows an outer housing 20, a sealing element 70, two shielding elements 30, two female terminals 10, two wires 60 each connected to each of the two female terminals 10, respectively, a cover 40 and an overmold 50. FIG. 2a shows a female connector 2, a bent portion 11, a receiving portion, a cavity 21 in the outer housing 20, and an opening 22. FIG. 2b shows a mated condition with a male terminal 65. The connection system 1 of the prior art shows that the female terminal 10 is not positioned correctly. The female terminal 10 is oblique and not parallel to the mating direction MD. Particularly the tulips are not at their correct position (as best seen in FIG. 2c).

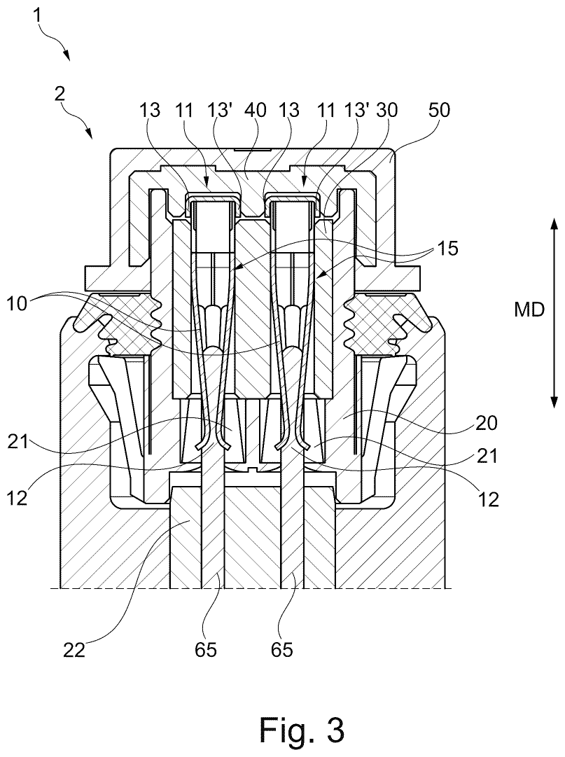

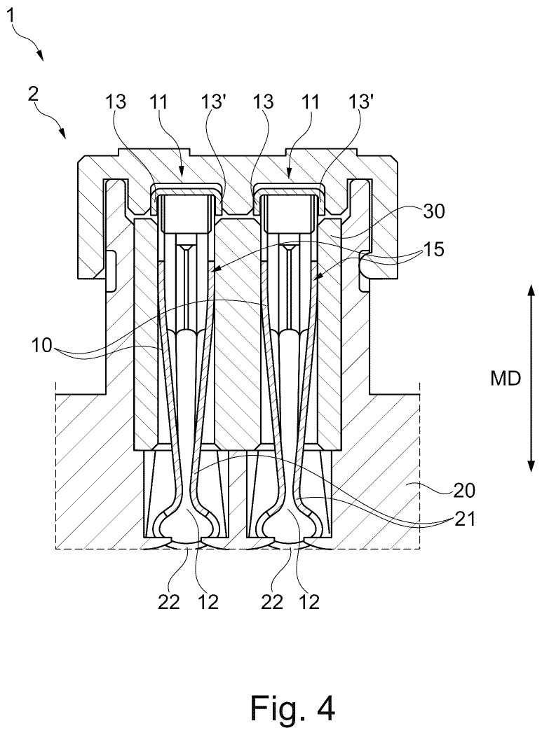

FIG. 3, FIG. 4, and FIG. 4 show an electrical connection system 1 according to an embodiment of the present disclosure. As can be seen, the bent portion 11 of the female terminal 10 has at least one supporting element 13 for supporting the female terminal 10 on a surface 23 of the outer housing 20 such that movement of the female terminal 10 in the outer housing 20 is substantially prevented.

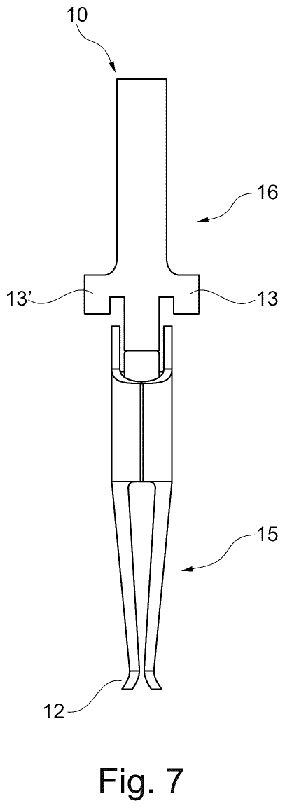

The at least one female terminal 10 (two of which are shown in FIGS. 3, 4, and 5) comprises a first elongate portion 15 oriented substantially parallel to the mating direction MD and being received at least partially within a hollow portion of the outer housing 20, a second elongate portion 16 oriented in a different direction than the mating direction MD. The hollow portion may comprise a part of the cavity 21. The bent portion 13 is arranged between the first 15 and the second 16 elongate portion. The supporting member 13 is arranged such that a free edge thereof contacts the surface 23 of the outer housing 20. In particular, the free edge abuts the surface 23 along its length in the direction of the second elongate portion 16. The supporting member 13 is bent in the mating direction MD and extends from the second elongate portion 16. As can be seen best in FIG. 7, the supporting member 13, 13′ has the shape of a wing.

As best seen in FIGS. 3 and 4, the surface 23 of the outer housing 20 is provided with a corresponding recess for each of the supporting member 13, 13′, so as to accommodate them at least partially.

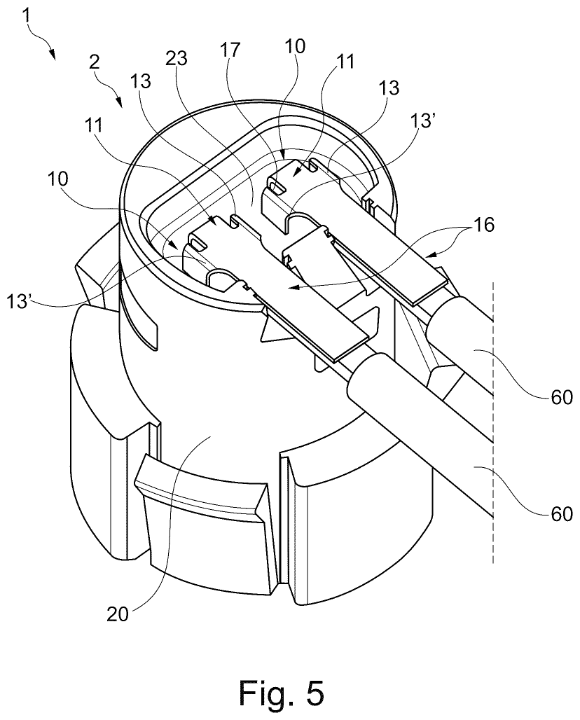

As best seen in FIG. 5, each of the supporting member 13, 13′ comprises a slit 17 (merely one is indicated for brevity) on an edge facing the second elongate portion 16. The slit 17 extends along the elongate direction of the second elongate portion 16. The slit 17 starts in proximity to an intersection of the first elongate portion 15 (as seen in FIGS. 3 and 4) and the second elongate portion 16 and extends in the direction along the second elongate portion 16.

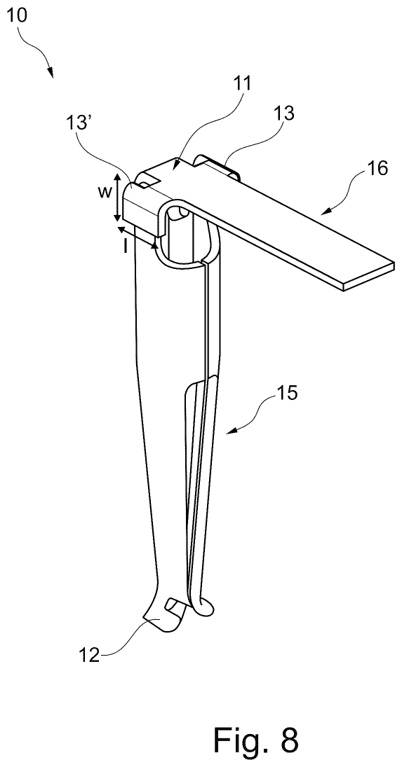

The first elongate portion 15 and the second elongate portion 16 intersect in the bent portion 11 with a bending radius 18 (as indicated in FIG. 2b of the prior art) as described elsewhere herein. The width w and length 1 of the supporting member 13, 13′ are indicated in FIG. 8. The first elongate portion 15 and the second elongate portion 16 may intersect at the bent portion 11 at an angle of about 90°.

The surface 23 is a top surface arranged on an end of the outer housing 20 opposite to the receiving portion 12 and substantially perpendicular to the mating direction MD.

As indicated in all figures, the bent portion 11 encompasses a portion that is greater than the mathematical point or edge at which an extension of each of the first elongate portion 15 and the second elongate portion 16 intersect.

As best seen in FIGS. 3 and 4, the receiving portion 12 may be arranged substantially centrally in the opening 22 as seen along the mating direction MD. The receiving portion 12 of the female terminal 10 may be spaced apart from the opening 22 by a predefined distance. The supporting member 13 may be configured to maintain a predefined distance between the second elongate portion 16 and the surface 23 of the outer housing 20. As best seen in FIG. 3 and FIG. 4, an annular gap is formed between the first elongate portion 15 and the hollow portion of the outer housing 20. The annular gap may be substantially uniform along its circumference. These advances cannot be achieved with the electrical connection system 1 of the prior art (FIGS. 1, 2a, 2b, and 2c).

Wires 60 as used in the electrical connection system 1 of the present disclosure may have a cross sectional area of 0.2 mm² to 0.8 mm, preferably 0.3 mm² to 0.6 mm², preferably 0.35 mm² to 0.5 mm².

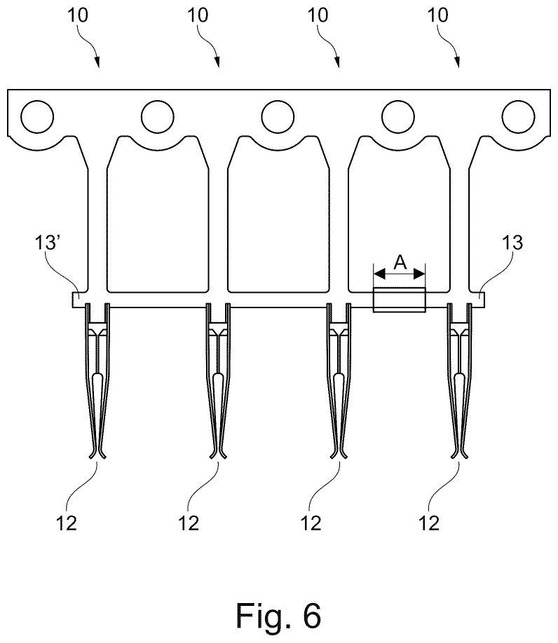

FIGS. 6, 7, and 8 show different steps of a manufacturing process of a female terminal 10 according to an embodiment of the present disclosure.

As can be seen, the supporting members 13, 13′ (only two of which are indicated in FIG. 6 for brevity) are integrally formed with the female terminal 10 as a single piece. The female terminal 10 and the supporting member 13, 13′ are made from stamped and bent sheet metal. A portion A between each female terminal 10 is cut off as best seen in FIG. 6. This allows that the supporting members 13, 13′ adopt the shape of wings. The female terminal 10 is bent to about 90° as seen in FIG. 8 compared to FIG. 7.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

The term “and/or” is only an association relationship describing associated objects and represents that three relationships may exist. For example, A and/or B may represent three conditions: i.e., independent existence of A, existence of both A and B and independent existence of B. In addition, the character “/” in the disclosure usually represents that previous and next associated objects form an “or” relationship.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. An electrical connection system for automotive applications, comprising:
an outer housing defining a mating direction; and
a female terminal comprising a first elongate portion oriented substantially parallel to the mating direction and being received at least partially within a hollow portion of the outer housing, a second elongate portion oriented in a different direction than the mating direction, and a bent portion arranged between the first elongate portion and the second elongate portion, wherein the first elongate portion has a receiving portion opposite to the bent portion for mating with a corresponding male terminal, and wherein the bent portion has a supporting member for supporting the female terminal on a surface of the outer housing such that movement of the female terminal in the outer housing is substantially prevented.

2. The electrical connection system according to claim 1, wherein the supporting member is arranged such that a free edge of the supporting member contacts the surface at least partially.

3. The electrical connection system according to claim 2, wherein the supporting member is bent in the mating direction and extends from the second elongate portion such that the free edge substantially abuts the surface along its length in a direction of the second elongate portion.

4. The electrical connection system according to claim 1, wherein the supporting member has a wing shape.

5. The electrical connection system according to claim 1, wherein the supporting member is integrally formed with the female terminal as a single piece.

6. The electrical connection system according to claim 5, wherein the female terminal and the supporting member are made from stamped and bent sheet metal.

7. The electrical connection system according to claim 1, wherein the surface of the outer housing is provided with a corresponding recess so as to accommodate the supporting member at least partially.

8. The electrical connection system according to claim 1, wherein the supporting member comprises a slit on an edge facing the second elongate portion, the slit extending along an elongate direction of the second elongate portion.

9. The electrical connection system according to claim 8, wherein the slit starts in proximity of an intersection of the first elongate portion and the second elongate portion and extends in a direction along the second elongate portion.

10. The electrical connection system according to claim 8, wherein the slit extends to at least 5% of a length of the supporting member in a direction along the second elongate portion and wherein the slit extends to at most 80% of the length of the supporting member in a direction along the second elongate portion.

11. The electrical connection system according to claim 1, wherein the first elongate portion and the second elongate portion intersect in the bent portion with a bending radius of between 0.05 mm and 0.8 mm.

12. The electrical connection system according to claim 1, wherein the supporting member has a width in a direction perpendicular to the second elongate portion towards the surface of at least 0.2 mm and wherein the supporting member has a width in a direction perpendicular to the second elongate portion towards the surface of at most 4 mm.

13. The electrical connection system according to claim 1, wherein the supporting member has a length in a direction along the second elongate portion of at least 0.4 mm and wherein the supporting member has a length in a direction along the second elongate portion of at most 4 mm.

14. The electrical connection system according to claim 1, wherein the first elongate portion and the second elongate portion intersect in the bent portion by an angle of at least 60 and by an angle of at most 120°.

15. The electrical connection system according to claim 1, wherein the surface is a top surface arranged on an end of the outer housing opposite to the receiving portion and substantially perpendicular to the mating direction.

16. The electrical connection system according to claim 1, wherein the bent portion encompasses a portion of the female terminal of at least 1 time of a bending radius of an intersection of an extension of the first elongate portion and an extension of the second elongate portion.

17. The electrical connection system according to claim 1, wherein the bent portion encompasses a portion of the female terminal of at most 20 times of a bending radius of an intersection of an extension of the first elongate portion and an extension of the second elongate portion.

18. The electrical connection system according to claim 1, wherein the bent portion has two supporting members arranged substantially symmetrically on opposite sides of the bent portion, wherein the surface of the outer housing is provided with two corresponding recesses arranged substantially symmetrically on opposite sides of the bent portion so as to accommodate the two supporting members at least partially.

19. A method for assembling an electrical connection system, the method comprising:
providing an electrical connection system having an outer housing defining a mating direction and a female terminal comprising a first elongate portion oriented substantially parallel to the mating direction and being received at least partially within a hollow portion of the outer housing, a second elongate portion oriented in a different direction than the mating direction, and a bent portion arranged between the first elongate portion and the second elongate portion, wherein the first elongate portion has a receiving portion opposite to the bent portion for mating with a corresponding male terminal, and wherein the bent portion has a supporting member for supporting the female terminal on a surface of the outer housing such that movement of the female terminal in the outer housing is substantially prevented;
providing a cover on top of the surface of the outer housing for covering the outer housing and the female terminal at least partially; and
providing an overmold on top of the cover configured to accommodate the cover and a wire at least partially.

20. The method according to claim 19, further comprising:
providing a sealing element between the overmold and the outer housing; and
connecting the wire to the second elongate portion at an end portion thereof opposite the bent portion of the female terminal.
